(19) United States
(12) Patent Application Publication
(10) Pub. No.: US 2006/0209074 A1
(43) Pub. Date: Sep. 21, 2006

(54) Methods and portable apparatuses for displaying characters

(75) Inventor: Yi-Shiuan Shen, Taipei City (TW)

Correspondence Address: BIRCH STEWART KOLASCH & BIRCH, PO BOX 747, FALLS CHURCH, VA, 22040-0747, US

(73) Assignee: BENQ CORPORATION

(21) Appl. No.: 11/350,887

(22) Filed: Feb. 10, 2006

(30) Foreign Application Priority Data
Feb. 14, 2005 (TW) 94104177

(51) Int. Cl. G06T 11/00

(52) U.S. Cl. 345/467; 345/472

(57) ABSTRACT

A method for character display receives a request comprising information regarding a character to be displayed on an area corresponding to a first coordinate on a screen, acquires a bitmap image corresponding to the character, determines at least one second coordinate near the first coordinate, draws the bitmap image on the screen based on the second coordinate, and draws the bitmap image on the screen based on the first coordinate.

### BACKGROUND

The present invention relates to character display, and more particularly, to methods and portable apparatuses for displaying characters.

Portable apparatuses, such as mobile devices, PDAs (personal digital assistants), MP3 players, portable hard drives and the like, are designed to be small enough to meet mobility requirements. In order to reduce size, portable apparatuses provide a relatively small screen for display, resulting in blurred characters.

### SUMMARY

Character display methods, performed by a portable apparatus with a screen, are provided. An embodiment of a character display method receives a request comprising information regarding a character to be displayed on an area corresponding to a first coordinate on a screen, acquires a bitmap image corresponding to the character, determines at least one second coordinate near the first coordinate, draws the bitmap image on the screen based on the second coordinate, and draws the bitmap image on the screen based on the first coordinate.

A machine-readable storage medium storing a computer program which, when executed by a portable apparatus, performs the method of character display is also provided.

Portable apparatuses for character display are provided. An embodiment of a portable apparatus comprises a screen and a control unit. The control unit receives a request comprising information regarding a character to be displayed on an area corresponding to a first coordinate on a screen, acquires a bitmap image corresponding to the character, determines at least one second coordinate near the first coordinate, draws the bitmap image on the screen based on the second coordinate, and draws the bitmap image on the screen based on the first coordinate.

The portable apparatuses may be mobile devices, PDAs (personal digital assistants), digital music players, portable disk drives or portable electronic devices. Wherein, the first and second drawing operations may draw the bitmap image using the same color or different colors respectively. The distance between the first and second coordinates may be one or two pixels.

If the first coordinate is (x,y), the second coordinate/coordinates may be one of the followings. In one aspect, the second coordinate may be (x−1,y−1), (x−1,y), (x−1,y+1), (x,y−1), (x,y+1), (x+1,y−1), (x+1,y) or (x+1,y+1). In another aspect, the second coordinates may be (x−1,y), (x,y−1), (x,y+1) and (x+1,y). In still another aspect, the second coordinates may be (x−1,y−1), (x−1,y), (x−1,y+1), (x,y−1), (x,y+1), (x+1,y−1), (x+1,y) and (x+1,y+1). In the other aspect, the second coordinates may be (x−2,y), (x−1,y), (x+1,y), (x+2,y), (x,y−2), (x,y−1), (x,y+1) and (x,y+2).

### DESCRIPTION OF THE DRAWINGS

The invention will become more fully understood by referring to the following detailed description with reference to the accompanying drawings, wherein:

FIG. 1 is a diagram of a hardware environment applicable to an embodiment of a mobile device;

FIG. 2 is a flowchart of an embodiment of a character display method;

FIG. 3 is a diagram of a storage medium storing a computer program providing an embodiment of a method of character display;

FIG. 4 is a diagram showing an exemplary bitmap image;

FIG. 5 is an exemplary screen diagram;

FIGS. 6a, 6b, 7a, 7b, 8a, 8b, 9a, 9b, 10a and 10b are exemplary screen diagrams in various aspects.

### DETAILED DESCRIPTION

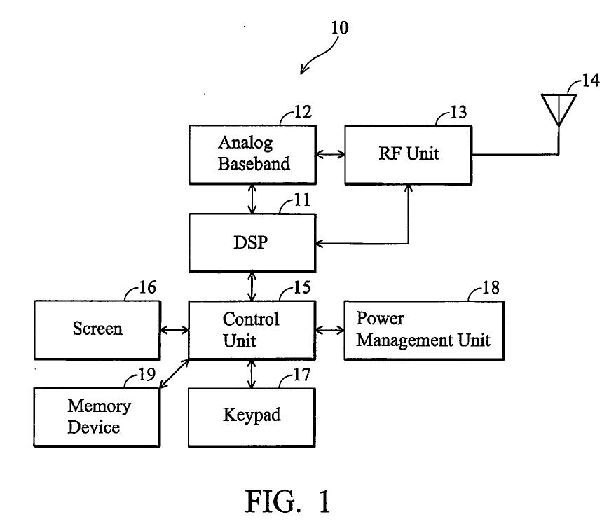

FIG. 1 is a diagram of a hardware environment applicable to an embodiment of a mobile device 10 comprising a DSP (digital signal processor) 11, an analog baseband 12, a RF (Radio Frequency) unit 13, an antenna 14, a control unit 15, a screen 16, a keypad 17, a power management unit 18 and a memory device 19. Moreover, those skilled in the art will understand that some embodiments may be practiced with other embedded system devices, including PDA (digital personal assistant), digital music player, portable disk drive, programmable consumer electronics, and the like. The control unit 15 may be a micro-processor (MPU) unit loading and executing character display methods from the memory device 19. The memory device 19 is preferably a random access memory (RAM), but may also include read-only memory (ROM) or flash ROM, storing tested modules.

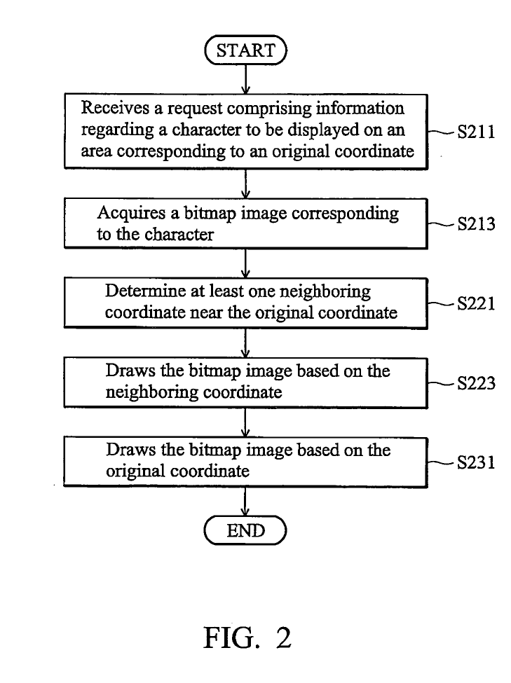

FIG. 2 is a flowchart of an embodiment of a character display method. In step S211, a display request comprising information regarding a character to be displayed on an area corresponding to an original coordinate is received. In step S213, a bitmap image corresponding to the character is acquired. In step S221, at least one neighboring coordinate corresponding to the original coordinate is determined. For example, If the original coordinate is (x,y), the neighboring coordinate may be at least one of (x−1,y−1), (x−1,y), (x−1,y+1), (x,y−1), (x,y+1), (x+1,y−1), (x+1,y) and (x+1,y+1). In steps S223, the bitmap image corresponding to the received character is drawn based on the determined neighboring coordinate. If the amount of the determined neighboring coordinates is more than one, the bitmap image corresponding to the received character is drawn repeatedly until all the determined coordinates are completely processed. In step S231, the bitmap image corresponding to the received character is drawn based on the original coordinate. Note that the bitmap image corresponding to the received character may be drawn using the same color in both steps S223 and S231, enabling the received character to be displayed in a bold font, and otherwise, the bitmap image may be drawn using different colors in steps S223 and S231 respectively. Thus, the received character can be drawn with a frame or a shadow.

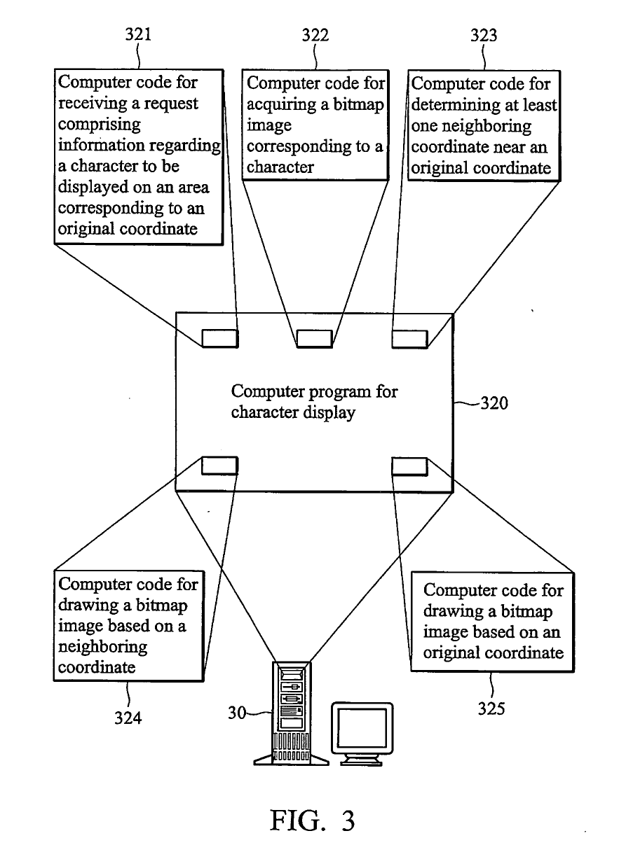

Also disclosed is a storage medium as shown in FIG. 3 storing a computer program 320 providing the disclosed methods for displaying characters. The computer program includes a storage medium 30 having computer readable program code therein for use in a computer system. The computer readable program code comprises at least computer readable program code 321 receiving a display request comprising information regarding a character to be displayed on an area corresponding to an original coordinate, computer readable program code 322 acquiring a bitmap image corresponding to a character, computer readable program code 323 determining at least one neighboring coordinate corresponding to an original coordinate, computer readable program code 324 drawing a bitmap image based on at least one neighboring coordinate, and computer readable program code 425 drawing an bitmap image based on an original coordinate.

Portable apparatuses and character display methods, or certain aspects or portions thereof, may take the form of program code (i.e., instructions) embodied in tangible media, such as floppy diskettes, CD-ROMS, hard drives, nonvolatile memory devices, or any other machine-readable storage medium, wherein, when the program code is loaded into and executed by a machine, such as portable apparatuses and the like, the machine becomes an apparatus for practicing the invention. The disclosed methods and apparatuses may also be embodied in the form of program code transmitted over some transmission medium, such as electrical wiring or cabling, through fiber optics, or via any other form of transmission, wherein, when the program code is received and loaded into and executed by a portable apparatus, such as a mobile device or a PDA (personal digital assistant), the machine becomes an apparatus for practicing the invention. When implemented on a general-purpose processor, the program code combines with the processor to provide a unique apparatus that operates analogously to specific logic circuits.

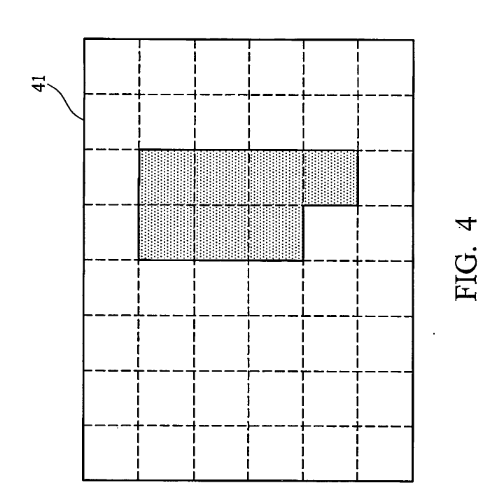

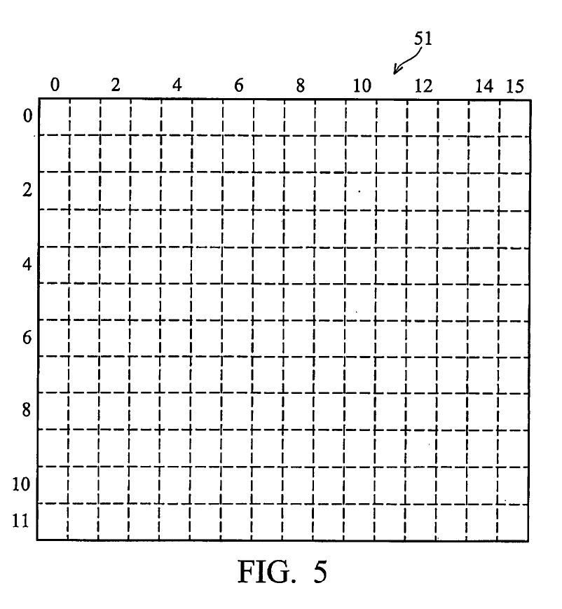

Details of the method for displaying characters are illustrated in the following. FIG. 4 is a diagram showing an exemplary bitmap image 41 in 8×6 pixels, depicting a comma. FIG. 5 is an exemplary screen diagram 51 of an area comprising 16×12 pixels on the screen 16. The coordinate at the uppermost and leftmost position is (0,0).

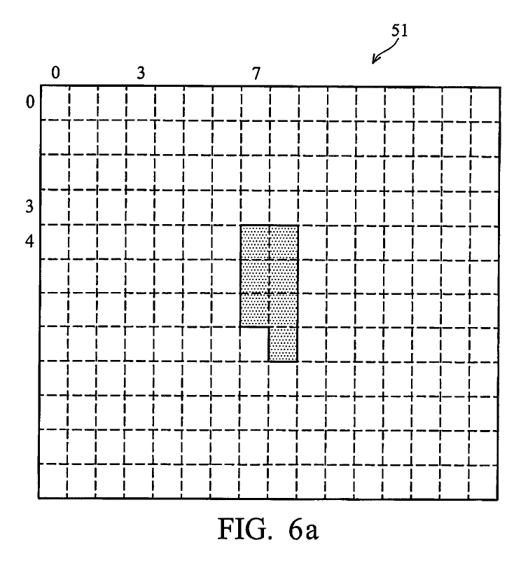

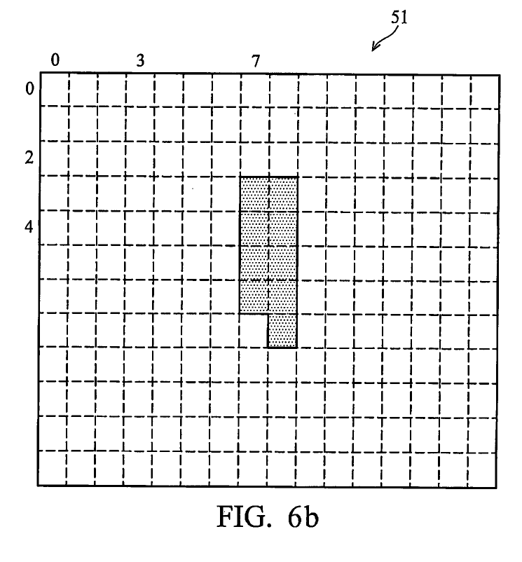

In a first example, a comma is displayed in a bold font using an embodiment of a character display method. FIGS. 6a and 6b are exemplary screen diagrams in various aspects. In step S211, a display request comprising information regarding a comma to be displayed on an area corresponding to an original coordinate (3,2) is received. In step S213, the bitmap image 41 corresponding to the comma is acquired. In step S221, a neighboring coordinate (3,3) is determined. In step S223, the bitmap image 41 corresponding to the comma is drawn based on the neighboring coordinate (3,3), the result is depicted in FIG. 6a. In step S231, the bitmap image 41 is drawn based on the original coordinate (3,2). The drawn bitmap image 41 has the same color as in step S221, the result is depicted in FIG. 6b.

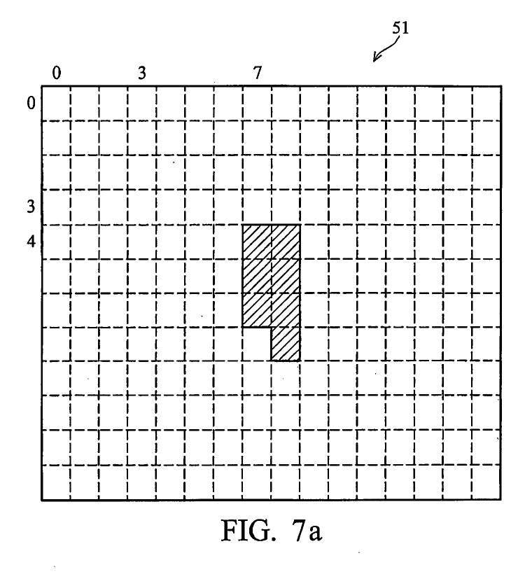

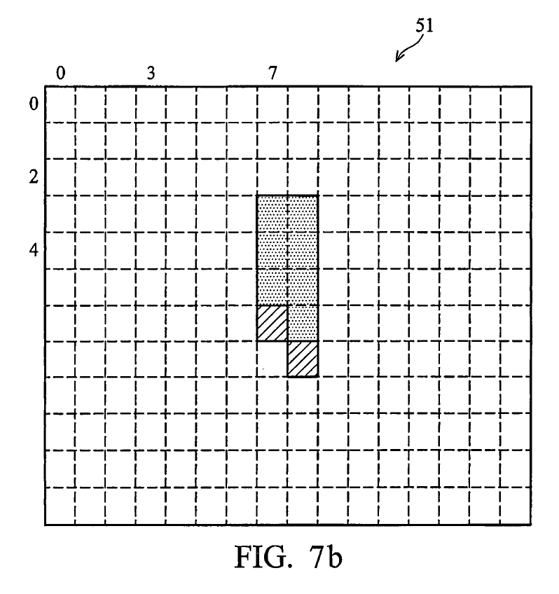

In a second example, a comma is displayed with a shadow of a different color using an embodiment of a character display method. FIGS. 7a and 7b are exemplary screen diagrams in various aspects. In step S211, a display request comprising information regarding a comma to be displayed on an area corresponding to an original coordinate (3,2) is received. In step S213, the bitmap image 41 corresponding to the comma is acquired. In step S221, a neighboring coordinate (3,3) is determined. In step S223, the bitmap image 41 corresponding to the comma is drawn based on the neighboring coordinate (3,3), the result is shown in FIG. 7a. In step S231, the bitmap image 41 is drawn based on the original coordinate (3,2). The drawn bitmap image 41 has a different color than in step S221, the result is shown in FIG. 7b.

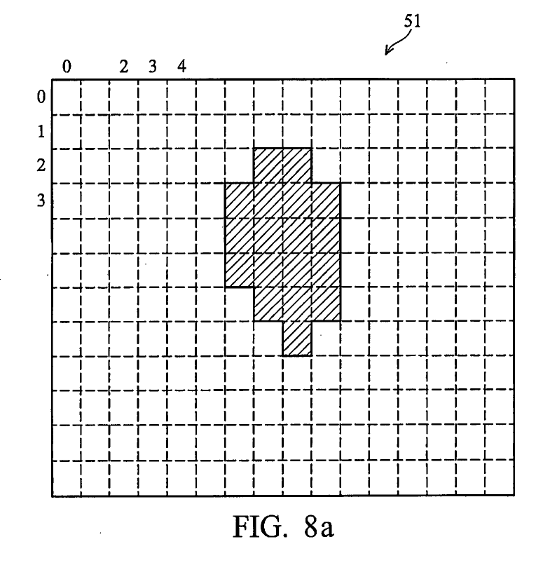

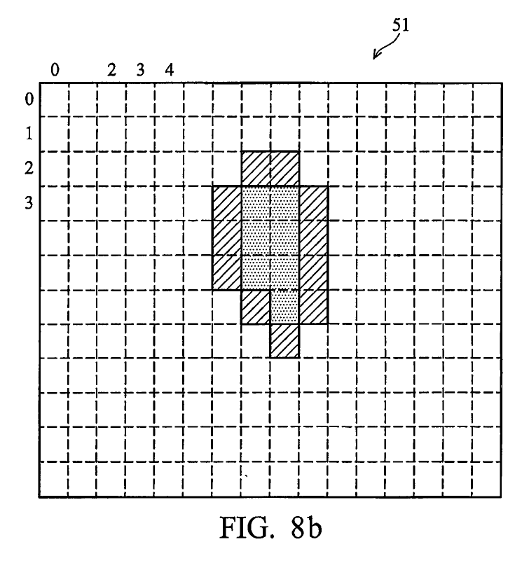

In a third example, a comma is displayed with a frame of a different color using an embodiment of a character display method, the length of the frame being one. FIGS. 8a and 8b are exemplary screen diagrams in various aspects. In step S211, a display request comprising information regarding a comma to be displayed on an area corresponding to an original coordinate (3,2) is received. In step S213, the bitmap image 41 corresponding to the comma is acquired. In step S221, multiple neighboring coordinates (2,2), (4,2), (3,1) and (3,3) are determined. In step S223, the bitmap image 41 corresponding to the comma is repeatedly drawn based on the neighboring coordinates (2,2), (4,2), (3,1) and (3,3), the result is shown in FIG. 8a. In step S231, the bitmap image 41 is drawn based on the original coordinate (3,2). The drawn bitmap image 41 has a different color than in step S221, the result as shown in FIG. 8b.

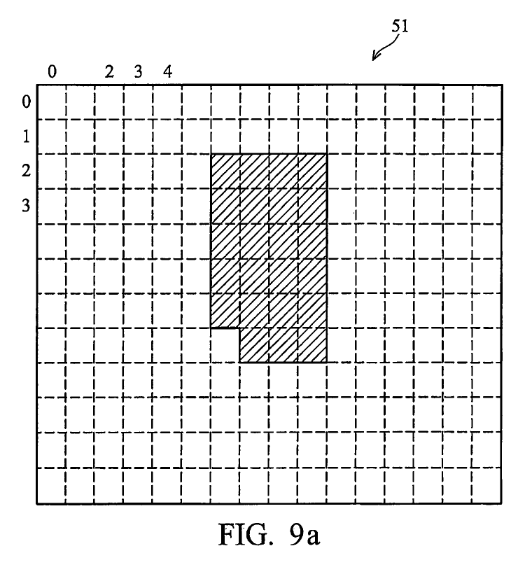

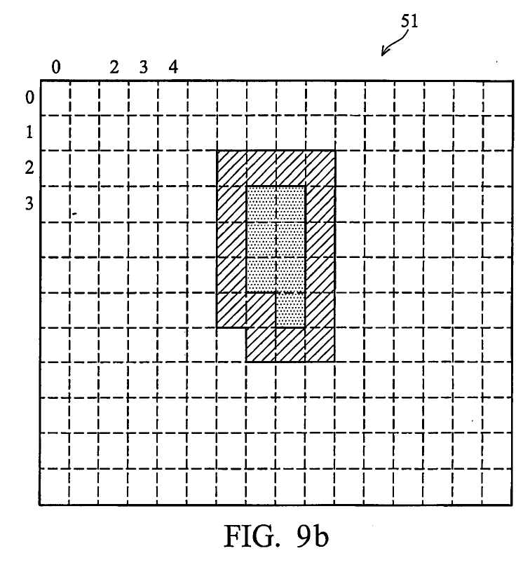

In a fourth example, a comma is displayed with a frame of a different color using an embodiment of a character display method, the length of the frame being one. FIGS. 9a and 9b are exemplary screen diagrams in various aspects. In step S211, a display request comprising information regarding a comma to be displayed on an area corresponding to an original coordinate (3,2) is received. In step S213, the bitmap image 41 corresponding to the comma is acquired. In step S221, multiple neighboring coordinates (2,2), (4,2), (3,1), (3,3), (2,1), (2,3), (4,1) and (4,3) are determined. In step S223, the bitmap image 41 corresponding to the comma is repeatedly drawn based on the neighboring coordinates (2,2), (4,2), (3,1), (3,3), (2,1), (2,3), (4,1) and (4,3), the result is shown in FIG. 9a. In step S231, the bitmap image 41 is drawn based on the original coordinate (3,2). The drawn bitmap image 41 has a different color than in step S221, the result is shown in FIG. 9b.

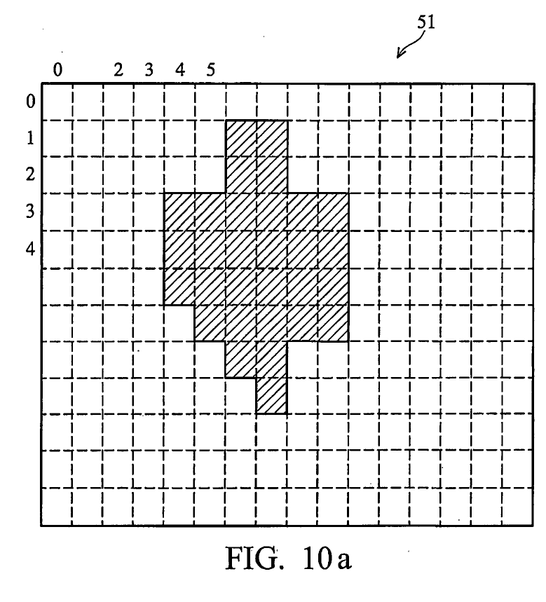

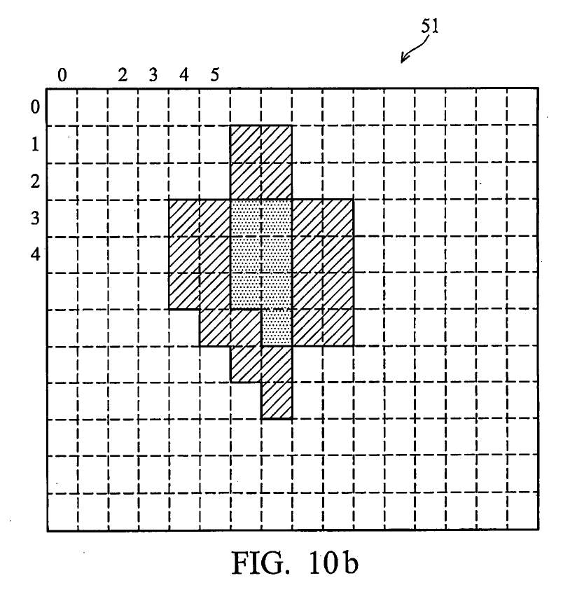

In a fifth example, a comma is displayed with a frame of a different color using an embodiment of a character display method, the length of the frame being two. Figs. 10a and 10b are exemplary screen diagrams in various aspects. In step S211, a display request comprising information regarding a comma to be displayed on an area corresponding to an original coordinate (3,2) is received. In step S213, the bitmap image 41 corresponding to the comma is acquired. In step S221, multiple neighboring coordinates (1,2), (2,2), (4,2), (5,2), (3,0), (3,1), (3,3) and (3,4) are determined. In step S223, the bitmap image 41 corresponding to the comma is repeatedly drawn based on neighboring coordinates (1,2), (2,2), (4,2), (5,2), (3,0), (3,1), (3,3) and (3,4), the result is shown in Fig. 10a. In step S231, the bitmap image 41 is drawn based on the original coordinate (3,2). The drawn bitmap image 41 has a different color than in step S221, the result is shown in Fig. 10b.

While the invention has been described in terms of preferred embodiment, it is not intended to limit the invention to the precise embodiments disclosed herein. Those who are skilled in this technology can still make various alterations and modifications without departing from the scope and spirit of this invention. Therefore, the scope of the invention shall be defined and protected by the following claims and their equivalents.

What is claimed is:

1. A method of character display, performed by a portable apparatus with a screen, comprising:
receiving a request comprising information regarding a character to be displayed on an area corresponding to a first coordinate on the screen;
acquiring a bitmap image corresponding to the character;
determining at least one second coordinate near the first coordinate;
performing a first drawing operation to draw the bitmap image on the screen based on the second coordinate; and
performing a second drawing operation to draw the bitmap image on the screen based on the first coordinate.

2. The method as claimed in claim 1 wherein the first and second drawing operations draw the bitmap image in the same color.

3. The method as claimed in claim 1 wherein the first and second drawing operations respectively draw the bitmap image in different colors.

4. The method as claimed in claim 1 wherein the first coordinate is (x,y).

5. The method as claimed in claim 4 wherein the second coordinate is (x−1,y−1), (x−1,y), (x−1,y+1), (x,y−1), (x,y+1), (x+1,y31 1), (x+1,y) or (x+1,y+1).

6. The method as claimed in claim 4 wherein the second coordinates are (x−1,y), (x,y−1), (x,y+1) and (x+1,y).

7. The method as claimed in claim 4 wherein the second coordinates are (x−1,y−1), (x−1,y), (x−1,y+1), (x,y−1), (x,y+1), (x+1,y−1), (x+1,y) and (x+1,y+1).

8. The method as claimed in claim 4 wherein the second coordinates are (x−2,y), (x−1,y), (x+1,y), (x+2,y), (x,y−2), (x,y−1), (x,y+1) and (x,y+2).

9. The method as claimed in claim 1 wherein the distance between the first and second coordinates is one or two pixels.

10. A machine-readable storage medium for storing a computer program which, when executed by a portable apparatus with a screen, performs a method of character display, the method comprising:
receiving a request comprising information regarding a character to be displayed on an area corresponding to a first coordinate on the screen;
acquiring a bitmap image corresponding to the character;
determining at least one second coordinate near the first coordinate;
performing a first drawing operation to draw the bitmap image on the screen based on the second coordinate; and
performing a second drawing operation to draw the bitmap image on the screen based on the first coordinate.

11. The machine-readable storage medium as claimed in claim 10 wherein the portable apparatus is a mobile device, a PDA (personal digital assistant), a digital music player, a portable disk drive or a programmable consumer electronic.

12. A portable apparatus for character display, comprising:
a screen; and
a control unit receiving a request comprising information regarding a character to be displayed on an area corresponding to a first coordinate on the screen, acquiring a bitmap image corresponding to the character, determining at least one second coordinate near the first coordinate, performing a first drawing operation and performing a second drawing operation,
wherein the first drawing operation draws the bitmap image on the screen based on the second coordinate, and the second drawing operation draws the bitmap image on the screen based on the first coordinate.

13. The portable apparatus as claimed in claim 12 wherein the first and second drawing operations draw the bitmap image in the same color.

14. The portable apparatus as claimed in claim 12 wherein the first and second drawing operations respectively draw the bitmap image in different colors.

15. The portable apparatus as claimed in claim 12 wherein the first coordinate is (x,y).

16. The portable apparatus as claimed in claim 15 wherein the second coordinate is (x−1,y−1), (x−1,y), (x−1,y+1), (x,y−1), (x,y+1), (x+1,y−1), (x+1,y) or (x+1,y+1).

17. The portable apparatus as claimed in claim 15 wherein the second coordinates are (x−1,y), (x,y−1), (x,y+1) and (x+1,y).

18. The portable apparatus as claimed in claim 15 wherein the second coordinates are (x−1,y−1), (x−1,y), (x−1,y+1), (x,y−1), (x,y+1), (x+1,y−1), (x+1,y) and (x+1,y+1).

19. The portable apparatus as claimed in claim 15 wherein the second coordinates are (x−2,y), (x−1,y), (x+1,y), (x+2,y), (x,y−2), (x,y−1), (x,y+1) and (x,y+2).

20. The portable apparatus as claimed in claim 15 wherein the distance between the first and second coordinates is one or two pixels.
